(19) United States
(12) Patent Application Publication
(10) Pub. No.: US 2024/0287689 A1
(43) Pub. Date: Aug. 29, 2024

(54) MOUNTED REACTOR AND METHOD OF USE

(71) Applicant: Utility Global, Inc., Houston, TX (US)

(72) Inventors: Matthew Dawson, Katy, TX (US); Roderick Sidwell, Houston, TX (US); Paul Matthews, Houston, TX (US); Joshua Persky, Sutton, MA (US)

(73) Assignee: Utility Global, Inc., Houston, TX (US)

(21) Appl. No.: 18/433,150

(22) Filed: Feb. 5, 2024

Related U.S. Application Data
(60) Provisional application No. 63/448,174, filed on Feb. 24, 2023.

(51) Int. Cl. C25B 9/60; C25B 1/04; C25B 1/23

(52) U.S. Cl. CPC C25B 9/60; C25B 1/04; C25B 1/23

(57) ABSTRACT

Herein discussed is a device comprising a metal chamber having a first internal space; a plate and a connector in the first internal space; and a ceramic chamber having a second internal space, wherein the ceramic chamber is inside the metal chamber and the second internal space penetrates the plate; wherein the plate is configured to expand or contract and remain in contact with the connector such that the first and second internal spaces are not in fluid communication with one another. In an embodiment, the ceramic chamber wall is in contact with the plate but does not penetrate the plate. In an embodiment, the device produces no electricity and receives no electricity.

### CROSS-REFERENCE TO RELATED APPLICATIONS

This application claims the benefit under 35 U.S.C. 119(e) of U.S. Provisional Patent Application No. 63/448,174 filed Feb. 24, 2023, the entire disclosure of which is hereby incorporated herein by reference.

### TECHNICAL FIELD

This invention generally relates to reactors. More specifically, this invention relates to electrochemical reactors, for example, for production of hydrogen (H₂) or carbon monoxide (CO) or both.

### BACKGROUND

Carbon monoxide (CO) is a colorless, odorless, tasteless, and flammable gas that is slightly less dense than air. It is well known for its poisoning effect because CO readily combines with hemoglobin to produce carboxyhemoglobin, which is highly toxic when the concentration exceeds a certain level. However, CO is a key ingredient in many chemical and industrial processes. CO has a wide range of functions across all disciplines of chemistry, e.g., metal-carbonyl catalysis, radical chemistry, cation and anion chemistries. Carbon monoxide is a strong reductive agent and has been used in pyrometallurgy to reduce metals from ores for centuries. As an example for making specialty compounds, CO is used in the production of vitamin A.

Hydrogen (H₂) in large quantities is needed in the petroleum and chemical industries. For example, large amounts of hydrogen are used in upgrading fossil fuels and in the production of methanol or hydrochloric acid. Petrochemical plants need hydrogen for hydrocracking, hydrodesulfurization, hydrodealkylation. Hydrogenation processes to increase the level of saturation of unsaturated fats and oils also need hydrogen. Hydrogen is also a reducing agent of metallic ores. Hydrogen may be produced from electrolysis of water, steam reforming, lab-scale metal-acid process, thermochemical methods, or anaerobic corrosion. Many countries are aiming at a hydrogen economy.

In the Fischer-Tropsch process, CO and H₂ are both essential building blocks, which are often produced by converting carbon-rich feedstocks (e.g., coal). A mixture of CO and H₂—syngas—can combine to produce various liquid fuels, e.g., via the Fischer-Tropsch process. Syngas can also be converted to lighter hydrocarbons, methanol, ethanol, or plastic monomers (e.g., ethylene). The ratio of CO/H₂ is important in all such processes in order to produce the desired compounds. Conventional techniques require extensive and expensive separation and purification processes to obtain the CO and H₂ as building blocks.

Clearly there is increasing need and interest to develop new technological platforms to produce these building blocks and valuable products. This disclosure discusses new electrochemical devices that are suited for production of CO and H₂ via efficient electrochemical pathways. Furthermore, the method and system as disclosed herein do not require the extensive and expensive separation and purification processes as needed in traditional technologies.

### SUMMARY

Herein discussed is a device comprising a metal chamber having a first internal space; a plate and a connector in the first internal space; and a ceramic chamber having a second internal space, wherein the ceramic chamber is inside the metal chamber and the second internal space penetrates the plate; wherein the plate is configured to expand or contract and remain in contact with the connector such that the first and second internal spaces are not in fluid communication with one another. In an embodiment, the ceramic chamber wall is in contact with the plate but does not penetrate the plate. In an embodiment, the device produces no electricity and receives no electricity.

In an embodiment, the connector comprises a spring, a gasket, felt, a welded flange, or combinations of any two or more thereof. In an embodiment, the connector is made of thermiculite, mica, graphite, vermiculite, or combinations of any two or more thereof.

In an embodiment, the metal chamber is made of carbon steel, Incoloy, Inconel, stainless steel, duplex stainless steel, austenitic stainless-steel alloys, ferritic stainless alloys, martensitic stainless steel, or combinations of any two or more thereof. In an embodiment, Inconel comprises Inconel 600, Inconel 602A, Inconel 602AC, Inconel 617, Inconel 625, or combinations of any two or more thereof. In an embodiment, Stainless Steel comprises SS304, SS309, SS310, SS316, SS316L, SS410, SS430, SS446, or combinations of any two or more thereof.

In an embodiment, the plate is made of Incoloy, Inconel, stainless steel, austenitic stainless-steel alloys, ferritic stainless alloys, fecralloys, high nickel alloys, crofer APU-22, Hitachi ZMG232G10, CFY, or combinations of any two or more thereof. In an embodiment, Inconel comprises Inconel 600, Inconel 602A, Inconel 602AC, Inconel 617, Inconel 625, or combinations of any two or more thereof. In an embodiment, Stainless Steel comprises SS309, SS310, SS316, SS316L, SS410, SS430, SS446, or combinations of any two or more thereof. In an embodiment, fecralloys comprise FeCrAl alloys. In an embodiment, high nickel alloys comprise Haynes 230, RA 330, RA 333, 253 MA. In some cases, the closed bend is made of the same material as the plate.

In an embodiment, the ceramic chamber wall comprises an anode, a cathode, an electrolyte between and in contact with the anode and the cathode. In an embodiment, the cathode comprises Ni or NiO and a material selected from the group consisting of YSZ, CGO, SDC, SSZ, SCZ, LSGM, CoCGO, LST, and combinations of any two or more thereof.

In an embodiment, the anode and the cathode have the same elements. In an embodiment, the anode and the cathode comprise Ni-YSZ or LaSrFeCr-SSZ or LaSrFeCr-SCZ or LST (lanthanum-doped strontium titanate)-SCZ.

In an embodiment, the anode comprises Ni or NiO and a material selected from the group consisting of YSZ, CGO, SDC, SSZ, SCZ, LSGM, CoCGO, LST, and combinations of any two or more thereof. In an embodiment, the anode comprises doped or undoped ceria and a material selected from the group consisting of Cu, CuO, Cu2O, Ag, Ag2O, Au, Au2O, Au2O3, Pt, Pd, Ru, Rh, Ir, LaCaCr, LaSrCrFe, YSZ, CGO, SDC, SSZ, LSGM, LST, SCZ, stainless steel, and combinations of any two or more thereof.

In an embodiment, the electrolyte is electronically insulating. In an embodiment, the electrolyte is mixed-conducting. In an embodiment, the electrolyte comprises an electronically conducting phase and an ionically conducting phase; wherein the electronically conducting phase comprises doped lanthanum chromite or LST or an electronically conductive metal or combination thereof; and wherein the ionically conducting phase comprises a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia (SCZ), and combinations of any two or more thereof.

In an embodiment, the electrolyte comprises CoCGO or LST-stabilized zirconia. In an embodiment, the stabilized zirconia comprises YSZ or SSZ or SCZ (scandia-ceria-stabilized zirconia), and wherein the LST comprises LaSrCaTiO3. In an embodiment, the electrolyte comprises Nickel, Copper, Cobalt, Lanthanum, Strontium, Titanium, or Niobium-doped zirconia.

In an embodiment, the electrolyte, the anode, and the cathode have the same elements. In an embodiment, the electrolyte, the anode, and the cathode comprise Ni-YSZ or LaSrFeCr-SSZ or LaSrFeCr-SCZ or LST-SCZ.

In an embodiment, the anode and the cathode are both exposed to reducing environments during the entire time of operation. In an embodiment, the anode is configured to come in contact with a fuel. In an embodiment, the fuel comprises ammonia, syngas, hydrogen, methanol, carbon monoxide, a hydrocarbon, or combinations of any two or more thereof.

In an embodiment, the cathode is configured to reduce water to hydrogen electrochemically or configured to reduce carbon dioxide to carbon monoxide electrochemically. In an embodiment, the cathode is configured to simultaneously reduce water and carbon dioxide to hydrogen and carbon monoxide electrochemically.

In an embodiment, electrical resistance between the anode and cathode is no greater than ionic resistance between the anode and cathode for oxide ions. In an embodiment, the anode and the cathode each have a thickness of no greater than 100 microns. In an embodiment, the anode and the cathode each have a thickness of no greater than 20 microns.

In an embodiment, the ceramic chamber wall comprises a substrate. In an embodiment, the substrate is inert or wherein the substrate has the same elements as the electrode that the substrate is in contact with.

In an embodiment, the closed bend is an integral part of the ceramic chamber. In an embodiment, the closed bend is a separate part from the ceramic chamber and attached to the ceramic chamber such that the first and second internal spaces are not in fluid communication with one another. In an embodiment, the closed bend is made of nickel, nickel oxide, YSZ, NiO-YSZ, alumina, or combinations of any two or more thereof.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates a reactor, according to an embodiment of this disclosure.

FIG. 2A illustrates a section of a ceramic chamber in the reactor, according to an embodiment of this disclosure.

FIG. 2B illustrates a cross section of a ceramic chamber in the reactor, according to an embodiment of this disclosure.

### DETAILED DESCRIPTION

### Overview

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like. As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, compositions and materials are used interchangeably unless otherwise specified. Each composition/material may have multiple elements, phases, and components. Heating as used herein refers to actively adding energy to the compositions or materials.

As used herein, YSZ refers to yttria-stabilized zirconia; SDC refers to samaria-doped ceria; SSZ refers to scandia-stabilized zirconia; LSGM refers to lanthanum strontium gallate magnesite.

In this disclosure, no substantial amount of H₂ means that the volume content of the hydrogen is no greater than 5%, or no greater than 3%, or no greater than 2%, or no greater than 1%, or no greater than 0.5%, or no greater than 0.1%, or no greater than 0.05%.

As used herein, CGO refers to Gadolinium-Doped Ceria, also known alternatively as gadolinia-doped ceria, gadolinium-doped cerium oxide, cerium(IV) oxide, gadolinium-doped, GDC, or GCO, (formula Gd:CeO₂). CGO and GDC are used interchangeably unless otherwise specified. Syngas (i.e., synthesis gas) in this disclosure refers to a mixture consisting primarily of hydrogen, carbon monoxide and carbon dioxide.

A mixed conducting electrolyte is able to transport both electrons and ions. Ionic conductivity includes ionic species such as oxygen ions (or oxide ions), protons, halogenide anions, chalcogenide anions. In various embodiment, the mixed conducting electrolyte of this disclosure comprises an electronically conducting phase and an ionically conducting phase.

In this disclosure, the cross section of the tubulars is only illustrative and not limiting. The cross section of the tubulars is any suitable shape as known to one skilled in the art, such as circular, square, square with rounded corners, rectangle, rectangle with rounded corners, triangle, hexagon, pentagon, oval, irregular shape, etc. Axial direction is the direction along the length of the tubulars. Circumferential direction is the direction around the circumference of the cross section of the tubulars.

In this disclosure, electrical resistance between two points is the ratio between the voltage applied to the current flowing between the two points. The unit of electrical resistance is, for example, ohms. Ionic resistance between two points is the ratio between the voltage applied to the current flowing between the two points caused by ionic movement, such as oxide ions. The unit of ionic resistance is, for example, ohms.

As used herein, ceria refers to cerium oxide, also known as ceric oxide, ceric dioxide, or cerium dioxide, is an oxide of the rare-earth metal cerium. Doped ceria refers to ceria doped with other elements, such as samaria-doped ceria (SDC), or gadolinium-doped ceria (GDC or CGO). As used herein, chromite refers to chromium oxides, which includes all the oxidation states of chromium oxides.

A layer or substance being impermeable as used herein refers to it being impermeable to fluid flow. For example, an impermeable layer or substance has a permeability of less than 1 micro darcy, or less than 1 nano darcy.

In this disclosure, sintering refers to a process to form a solid mass of material by heat or pressure, or a combination thereof, without melting the material to the extent of liquefaction. For example, material particles are coalesced into a solid or porous mass by being heated, wherein atoms in the material particles diffuse across the boundaries of the particles, causing the particles to fuse together and form one solid piece.

The term “in situ” in this disclosure refers to the treatment (e.g., heating or cracking) process being performed either at the same location or in the same device. For example, ammonia cracking taking place in the electrochemical device at the anode is considered in situ.

Electrochemistry is the branch of physical chemistry concerned with the relationship between electrical potential, as a measurable and quantitative phenomenon, and identifiable chemical change, with either electrical potential as an outcome of a particular chemical change, or vice versa. These reactions involve electrons moving between electrodes via an electronically-conducting phase (typically, but not necessarily, an external electrical circuit), separated by an ionically-conducting and electronically insulating electrolyte (or ionic species in a solution). When a chemical reaction is effected by a potential difference, as in electrolysis, or if electrical potential results from a chemical reaction as in a battery or fuel cell, it is called an electrochemical reaction. Unlike chemical reactions, in electrochemical reactions electrons (and necessarily resulting ions), are not transferred directly between molecules, but via the aforementioned electronically conducting and ionically conducting circuits, respectively. This phenomenon is what distinguishes an electrochemical reaction from a chemical reaction.

Related to the electrochemical device and methods of use, various components of the reactor are described such as electrodes and electrolytes along with materials of construction of the components. The following description recites various aspects and embodiments of the inventions disclosed herein. No particular embodiment is intended to define the scope of the invention. Rather, the embodiments provide non-limiting examples of various compositions and methods that are included within the scope of the claimed inventions. The description is to be read from the perspective of one of ordinary skill in the art. Therefore, information that is well-known to the ordinarily skilled artisan is not necessarily included.

An interconnect in an electrochemical device (e.g., a fuel cell) is often either metallic or ceramic that is placed between the individual cells or repeat units. Its purpose is to connect each cell or repeat unit so that electricity can be distributed or combined. An interconnect is also referred to as a bipolar plate in an electrochemical device. An interconnect being an impermeable layer as used herein refers to it being a layer that is impermeable to fluid flow.

### Mounted Reactor

Contrary to conventional practice, a reactor having an electrochemical device has been discovered, which comprises an anode, a cathode, an electrolyte in contact with the anode and the cathode. The electrochemical reactions taking place in the reactor involve the exchange of ions and/or electrons through the electrolyte. These are different from traditional reactions via chemical pathways, which involve direct combination of reactants.

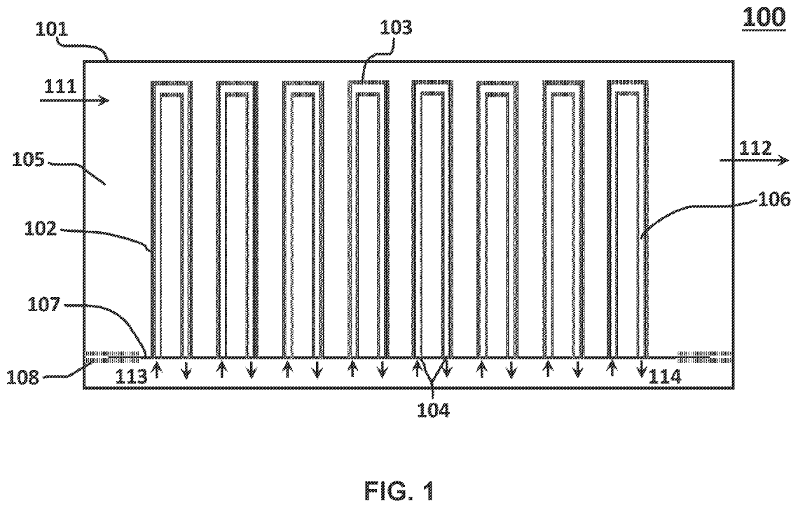

As illustrated in FIG. 1, reactor 100 comprises a metal chamber 101 having a first internal space 105; a plate 107 in the first internal space 105; and a ceramic chamber 102 having a second internal space 106, a closed bend 103, and two openings 104, wherein the ceramic chamber 102 is inside the metal chamber 101 and the second internal space 106 penetrates the plate 107 such that the two openings 104 and the bend 103 are on opposite sides of the plate 107; wherein the first and second internal spaces (105 and 106) are not in fluid communication with one another.

Fluid stream 111 enters the first internal space 105 and exits as stream 112. Fluid stream 113 enters the second internal space 106 and exits as stream 114. The plate 107 has corresponding penetrations to allow fluid flow (113, 114) through the openings (104). In various embodiments, the ceramic chamber wall is in contact with the plate but does not penetrate the plate. Reactor 100 also comprises at least one connector 108. In some cases, the connector comprises a spring, a gasket, felt, a welded flange, or combinations of any two or more thereof. In various embodiments, the connector is made of thermiculite, mica, graphite, vermiculite, or combinations of any two or more thereof. In some embodiments, the connector comprises a metal. In various embodiments, the plate 107 is configured to expand or contract and remain in contact with the connector 108 such that the first and second internal spaces are not in fluid communication with one another.

In an embodiment, the reactor generates no electricity and receives no electricity. In an embodiment, the closed bend 103 is an integral part of the ceramic chamber 102. In an embodiment, the closed bend is a separate part from the ceramic chamber and attached to the ceramic chamber such that the first and second internal spaces are not in fluid communication with one another. In an embodiment, the closed bend is made of Nickel, Nickel Oxide, YSZ, NiO-YSZ, Alumina, or combinations of any two or more thereof.

In some embodiments, the metal chamber is made of Carbon Steel, Incoloy, Inconel, Stainless Steel, Duplex Stainless Steel, Austenitic stainless-steel alloys, Ferritic Stainless Alloys, Martensitic stainless steel, or combinations of any two or more thereof. In some embodiments, Inconel comprises Inconel 600, Inconel 602A, Inconel 602AC, Inconel 617, Inconel 625, or combinations of any two or more thereof. In some embodiments, Stainless Steel comprises SS304, SS309, SS310, SS316, SS316L, SS410, SS430, SS446, or combinations of any two or more thereof.

In some embodiments, the plate is made of Incoloy, Inconel, Stainless Steel, Austenitic stainless-steel alloys, Ferritic Stainless Alloys, Fecralloys, High Nickel Alloys, Crofer APU-22, Hitachi ZMG232G10, CFY, or combinations of any two or more thereof. In some embodiments, Inconel comprises Inconel 600, Inconel 602A, Inconel 602AC, Inconel 617, Inconel 625, or combinations of any two or more thereof. In some embodiments, Stainless Steel comprises SS309, SS310, SS316, SS316L, SS410, SS430, SS446, or combinations of any two or more thereof. In some embodiments, Fecralloys comprise FeCrAl alloys. In some embodiments, High Nickel Alloys comprise Haynes 230, RA 330, RA 333, 253 MA.

In various embodiments, the closed bend is made of the same material as the plate. In various embodiments, there is a seal between the ceramic chamber wall and the closed bend as a separate part. In various embodiments, there is a seal between the ceramic chamber wall and the plate. In various embodiments, the seal comprises a glass seal or glue. In various embodiments, the seal is a glass seal or glue. Any suitable sealing material as known to one skilled in the art is contemplated to be within the scope of this disclosure.

### Ceramic Chamber

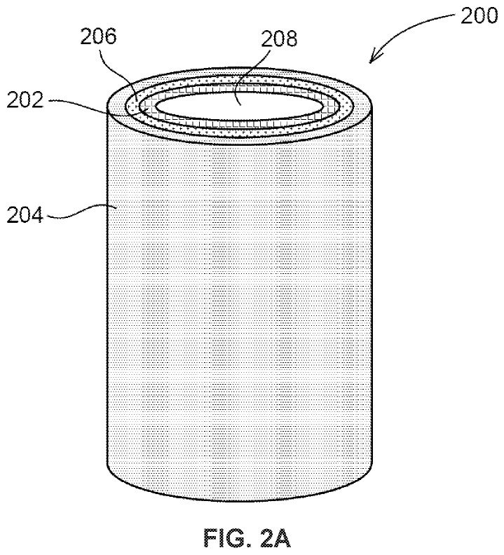

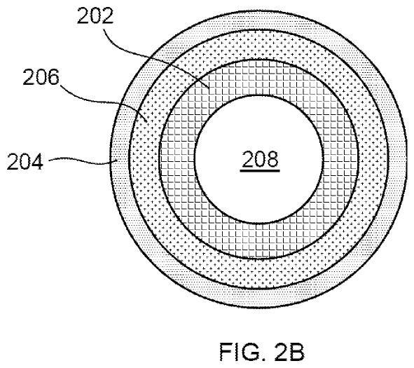

In various embodiments, the ceramic chamber is tubular. The cross section of the ceramic chamber may be any shape as known to one skilled in the art. FIGS. 2A and 2B are mere illustrations and not limiting. FIG. 2A illustrates a section 200 of the ceramic chamber, according to an embodiment of this disclosure. The ceramic chamber comprises a first electrode 202, an electrolyte 206, a second electrode 204, and an internal space 208. FIG. 2B illustrates a cross section of the ceramic chamber, according to an embodiment of this disclosure. The ceramic chamber comprises a first electrode 202, an electrolyte 206, a second electrode 204, and an internal space 208. The two electrodes (202 and 204) and the electrolyte (206) form the ceramic chamber wall as illustrated in FIGS. 2A and 2B.

In an embodiment, the ceramic chamber wall also comprises a substrate. In an embodiment, the substrate is inert or wherein the substrate has the same elements as the electrode that the substrate is in contact with. In some cases, the substrate is inert with regard to the operation conditions and the reactions.

In an embodiment, the ceramic chamber wall comprises an anode, a cathode, an electrolyte between and in contact with the anode and the cathode. In an embodiment, the cathode comprises Ni or NiO and a material selected from the group consisting of YSZ, CGO, SDC, SSZ, SCZ, LSGM, CoCGO, LST, and combinations of any two or more thereof.

In an embodiment, the anode and the cathode have the same elements. In an embodiment, the anode and the cathode comprise Ni-YSZ or LaSrFeCr-SSZ or LaSrFeCr-SCZ or LST (lanthanum-doped strontium titanate)-SCZ.

In an embodiment, the anode comprises Ni or NiO and a material selected from the group consisting of YSZ, CGO, SDC, SSZ, SCZ, LSGM, CoCGO, LST, and combinations of any two or more thereof.

In an embodiment, the anode comprises doped or undoped ceria and a material selected from the group consisting of Cu, CuO, Cu2O, Ag, Ag2O, Au, Au2O, Au2O3, Pt, Pd, Ru, Rh, Ir, LaCaCr, LaSrCrFe, YSZ, CGO, SDC, SSZ, LSGM, LST, SCZ, stainless steel, and combinations of any two or more thereof.

In an embodiment, the electrolyte is electronically insulating. In an embodiment, the electrolyte is mixed-conducting. In an embodiment, the electrolyte comprises an electronically conducting phase and an ionically conducting phase; wherein the electronically conducting phase comprises doped lanthanum chromite or LST or an electronically conductive metal or combination thereof; and wherein the ionically conducting phase comprises a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia (SCZ), and combinations of any two or more thereof.

In an embodiment, the electrolyte comprises CoCGO or LST-stabilized zirconia. In an embodiment, the stabilized zirconia comprises YSZ or SSZ or SCZ (scandia-ceria-stabilized zirconia), and wherein the LST comprises LaSrCaTiO3. In an embodiment, the electrolyte comprises Nickel, Copper, Cobalt, Lanthanum, Strontium, Titanium, or Niobium-doped zirconia.

In an embodiment, the electrolyte, the anode, and the cathode have the same elements. In an embodiment, the electrolyte, the anode, and the cathode comprise Ni-YSZ or LaSrFeCr-SSZ or LaSrFeCr-SCZ or LST-SCZ.

In an embodiment, the electrolyte comprises cobalt-CGO (CoCGO), i.e., cobalt doped CGO. In an embodiment, the electrolyte consists essentially of CoCGO. In an embodiment, the electrolyte consists of CoCGO. In an embodiment, the electrolyte comprises LST (lanthanum-doped strontium titanate)-YSZ or LST-SSZ or LST-SCZ (scandia-ceria-stabilized zirconia). In an embodiment, the electrolyte consists essentially of LST-YSZ or LST-SSZ or LST-SCZ. In an embodiment, the electrolyte consists of LST-YSZ or LST-SSZ or LST-SCZ. In this disclosure, LST-YSZ refers to a composite of LST and YSZ. In various embodiments, the LST phase and the YSZ phase percolate each other. In this disclosure, LST-SSZ refers to a composite of LST and SSZ. In various embodiments, the LST phase and the SSZ phase percolate each other. In this disclosure, LST-SCZ refers to a composite of LST and SCZ. In various embodiments, the LST phase and the SCZ phase percolate each other. YSZ, SSZ, and SCZ are types of stabilized zirconia's. In an embodiment, the LST comprises LaSrCaTiO₃. In an embodiment, the electrolyte comprises Nickel, Copper, Cobalt, or Niobium-doped zirconia.

In an embodiment, the anode and the cathode are both exposed to reducing environments during the entire time of operation. In an embodiment, the anode is configured to come in contact with a fuel. In an embodiment, the fuel comprises ammonia, syngas, hydrogen, methanol, carbon monoxide, a hydrocarbon, or combinations of any two or more thereof. In an embodiment, the cathode is configured to reduce water to hydrogen electrochemically or configured to reduce carbon dioxide to carbon monoxide electrochemically. In an embodiment, the cathode is configured to simultaneously reduce water and carbon dioxide to hydrogen and carbon monoxide electrochemically.

In an embodiment, electrical resistance between the anode and cathode is no greater than ionic resistance between the anode and cathode for oxide ions. In an embodiment, the anode and the cathode each have a thickness of no greater than 100 microns. In an embodiment, the anode and the cathode each have a thickness of no greater than 20 microns.

This device for CO and H₂ production according to this disclosure has various advantages. CO generation from CO₂ is desirable because it reduces greenhouse gas emission. Making CO and H₂ locally (on site) is inherently safer than transporting CO and H₂ in pressurized containers or vessels. The process of this disclosure utilizes efficient electrochemical pathways but yet needs no electricity. The CO/CO₂ and H₂/H₂O separation from the cathode exhaust is easy and inexpensive. As such, the method and system of this disclosure are cost competitive both in capital equipment and in operational expenses.

In various embodiments, the ratio of H₂/CO co-production is controlled by varying the input ratio of H₂O/CO₂, by varying the operation temperature, by varying the fuel composition, or combinations of any two or more thereof. As such, the produced H₂/CO is suitable for various downstream chemical productions without the need for further purification or modification. This is another major advantage of the process and system of this disclosure.

It is to be understood that this disclosure describes exemplary embodiments for implementing different features, structures, or functions of the invention. Exemplary embodiments of components, arrangements, and configurations are described to simplify the present disclosure; however, these exemplary embodiments are provided merely as examples and are not intended to limit the scope of the invention. The embodiments as presented herein may be combined unless otherwise specified. Such combinations do not depart from the scope of the disclosure.

Additionally, certain terms are used throughout the description and claims to refer to particular components or steps. As one skilled in the art appreciates, various entities may refer to the same component or process step by different names, and as such, the naming convention for the elements described herein is not intended to limit the scope of the invention. Further, the terms and naming convention used herein are not intended to distinguish between components, features, and/or steps that differ in name but not in function.

While the disclosure is susceptible to various modifications and alternative forms, specific embodiments thereof are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of this disclosure.

What is claimed is:

1. A device comprising
a metal chamber having a first internal space defined by at least one metal chamber wall;
a plate and a connector in the first internal space; and
a ceramic chamber having a second internal space defined by at least one ceramic chamber wall, wherein the ceramic chamber is inside the metal chamber and the second internal space penetrates the plate;
wherein the plate is configured to expand or contract and remain in contact with the connector such that the first and second internal spaces are not in fluid communication with one another.

2. The device of claim 1, wherein the connector comprises a spring, a gasket, felt, a welded flange, or combinations of any two or more thereof.

3. The device of claim 1, wherein the connector is made of thermiculite, mica, graphite, vermiculite, or combinations of any two or more thereof.

4. The device of claim 1, wherein the at least one metal chamber wall is made of carbon steel, Incoloy, Inconel, stainless steel, duplex stainless steel, austenitic stainless-steel alloys, ferritic stainless alloys, martensitic stainless steel, or a combination of any two or more thereof; wherein optionally Inconel comprises Inconel 600, Inconel 602A, Inconel 602AC, Inconel 617, Inconel 625, or combinations of any two or more thereof; and wherein optionally Stainless Steel comprises SS304, SS309, SS310, SS316, SS316L, SS410, SS430, SS446, or combinations of any two or more thereof.

5. The device of claim 1, wherein the plate is made of Incoloy, Inconel, stainless steel, austenitic stainless-steel alloys, ferritic stainless alloys, fecralloys, high nickel alloys, Crofer APU-22, Hitachi ZMG232G10, CFY, or combinations of any two or more thereof; wherein optionally Inconel comprises Inconel 600, Inconel 602A, Inconel 602AC, Inconel 617, Inconel 625, or combinations of any two or more thereof; wherein optionally Stainless Steel comprises SS309, SS310, SS316, SS316L, SS410, SS430, SS446, or combinations of any two or more thereof; wherein optionally fecralloys comprise FeCrAl alloys; wherein optionally high nickel alloys comprise Haynes 230, RA 330, RA 333, 253 MA.

6. The device of claim 1, wherein the at least one ceramic chamber wall comprises an anode, a cathode, and an electrolyte between and in contact with the anode and the cathode.

7. The device of claim 6, wherein the cathode comprises Ni or NiO and a material selected from the group consisting of YSZ, CGO, SDC, SSZ, SCZ, LSGM, CoCGO, LST, and combinations of any two or more thereof.

8. The device of claim 7, wherein the anode and the cathode have the same elements.

9. The device of claim 8, wherein the anode and the cathode comprise Ni-YSZ or LaSrFeCr-SSZ or LaSrFeCr-SCZ or LST (lanthanum-doped strontium titanate)-SCZ.

10. The device of claim 6, wherein the anode comprises Ni or NiO and a material selected from the group consisting of YSZ, CGO, SDC, SSZ, SCZ, LSGM, CoCGO, LST, and combinations of any two or more thereof.

11. The device of claim 6, wherein the anode comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, LST, SCZ, stainless steel, and combinations of any two or more thereof.

12. The device of claim 6, wherein the electrolyte comprises an electronically conducting phase and an ionically conducting phase; wherein the electronically conducting phase comprises doped lanthanum chromite or LST or an electronically conductive metal or combination thereof; and wherein the ionically conducting phase comprises a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia (SCZ), and combinations of any two or more thereof.

13. The device of claim 6, wherein the electrolyte comprises CoCGO or LST-stabilized zirconia, wherein the stabilized zirconia comprises YSZ or SSZ or SCZ (scandia-ceria-stabilized zirconia), and wherein the LST comprises LaSrCaTiO₃.

14. The device of claim 6, wherein the electrolyte comprises nickel, copper, cobalt, lanthanum, strontium, titanium, or niobium-doped zirconia.

15. The device of claim 6, wherein the electrolyte, the anode, and the cathode have the same elements.

16. The device of claim 15, wherein the electrolyte, the anode, and the cathode comprise Ni-YSZ or LaSrFeCr-SSZ or LaSrFeCr-SCZ or LST-SCZ.

17. The device of claim 6, wherein the at least one ceramic chamber wall further comprises a substrate.

18. The device of claim 17, wherein the substrate is inert or wherein the substrate is in contact with at least one of the anode and the cathode and has the same elements as the anode or the cathode that the substrate is in contact with.

19. The device of claim 6, wherein electrical resistance between the anode and the cathode is no greater than ionic resistance between the anode and the cathode for oxide ions.

20. The device of claim 1, wherein the ceramic chamber comprises a closed bend formed either as an integral part of the ceramic chamber or as a separate part of the ceramic chamber.

21. The device of claim 20, wherein the closed bend further defines the second internal space such that the first and second internal spaces are not in fluid communication with one another.

22. The device of claim 20, wherein the closed bend comprises a wall that is made of nickel, nickel oxide, YSZ, NiO-YSZ, alumina, or combinations of any two or more thereof or that is made of the same material as the plate.

23. The device of claim 1, wherein the at least one ceramic chamber wall is in contact with the plate but does not penetrate the plate.
